(19) United States
(12) Patent Application Publication
(10) Pub. No.: US 2020/0400025 A1
(43) Pub. Date: Dec. 24, 2020

(54) Pultrusion of Profiles Having Non-Uniform Cross Sections

(71) Applicant: TSC, LLC, Mojave, CA (US)

(72) Inventor: Rob Sjostedt, Tehachapi, CA (US)

(73) Assignee: TSC, LLC, Mojave, CA (US)

(21) Appl. No.: 16/904,926

(22) Filed: Jun. 18, 2020

Related U.S. Application Data
(60) Provisional application No. 62/864,285, filed on Jun. 20, 2019.

(51) Int. Cl. F01D 5/14; B29C 70/52

(52) U.S. Cl. CPC F01D 5/147; B29K 2063/00; F05D 2240/30; B29C 70/521

(57) ABSTRACT

Composite profiles, such as rotor blades, airfoils, I-beams, and box beams having non-uniform cross sections, and a system, method and process for pultrusion of composite profiles. The pultrusion of a heavier or thicker cross section portion of the composite profile is performed in-line and upstream from pultrusion of a thinner or lighter portion of the pultruded profile using a separate die for the thicker portion of the cross section, or leading edge slug, in order to optimize the processing conditions, productivity, and consistency of the composite profiles.

### CROSS-REFERENCE TO RELATED APPLICATIONS

This application claims priority under 35 USC Section 119(e) to co-pending U.S. Provisional Patent Application No. 62/864,285 filed on Jun. 20, 2019, the entire disclosure of which is incorporated herein by reference.

### FIELD OF THE INVENTION

This invention relates generally to pultrusion methods for hollow and solid pultruded profiles, such as rotor blades, airfoils, I-beams, and box beams, having non-uniform cross sections, and hollow and solid pultruded profiles made by these pultrusion methods.

### BACKGROUND OF THE INVENTION

Pultrusion is a continuous composite manufacturing process capable of making uniform and non-uniform cross section parts. Fibers, such as fiberglass or carbon fibers in various forms, are mechanically pulled through a resin bath, through shaping tooling, and through resin squeeze-out tooling. Then they pass through a heated steel die that cures the raw materials into a solid profile for use in various applications. For example, fiberglass pultrusions are commonly used for products such as ladder rails, chemical plant handrails and grating, tool handles, and highway delineator strips.

Prior pultruded products to date have had a relatively constant cross sectional thickness. Constant cross section unidirectional carbon pultrusions have been used in some wind turbine blade spars and large, developmental aircraft wing spars. The capability to pultrude hollow cross section parts is also emerging. For example, there have been low volume demonstrations of hollow airfoil shapes.

Prior art pultrusion operations use a single die for curing the pultrusion profile. If the pultrusion set-up is large enough, multiple streams of like pultrusions are made on the same machine using multiple dies running side-by-side, in what are called multiple streams. Prior art pultrusions on a large scale have been limited to a relatively constant cross sectional thickness throughout the cross section so that curing occurs evenly in the die.

Non-uniform cross-section pultrusions must be processed slower because the speed is limited by the time for curing the thickest portion of the cross section of the pultruded part. Therefore, the lack of an efficient method for pultrusion of non-uniform cross sections has been a limitation, for example, in the aerospace and aviation industry.

Pultrusion of aerospace grade lightweight hollow airfoil shapes has only been demonstrated on a limited research and development basis using a single pultrusion die. But, where large quantities of non-uniform cross section airfoil shapes are needed, such as for missile and drone wings, wind turbine blades, light helicopter rotor blades or electric vertical takeoff and landing (“eVTOL”) aircraft rotor blades, pultrusion could provide a low cost, high volume production method.

However, manufacturing non-uniform cross sections presents a processing challenge for conventional pultrusion using a single die. Profiles with non-uniform cross sections are more challenging to produce with high yields and consistency. For example, an eVTOL aircraft rotor blade or light helicopter rotor blade typically requires a heavy cross section, often referred to as the leading edge slug, in the leading edge and spar area of the non-uniform cross section airfoil to meet the structural and flight dynamics requirements. In addition, the remaining portion of the airfoil up to the trailing edge needs to be as light as possible to minimize the leading edge weight required for proper balance.

Accordingly, there are a large number of composite materials to cure in the leading edge slug and a much smaller number of composite materials to cure in the remaining portion of the profile body as it passes through the pultrusion die.

In addition, in some cases, additional leading edge weight must be added to the composite leading edge slug. This can be done by continuously inserting a metallic wire rope into the leading edge slug as it is processed and will add weight because the metallic insert is denser than fiberglass or carbon fiber composite.

Other pultruded applications may have the same issue where a spar area requires a heavy cross section for strength, while other areas need to be thin and light weight. It also may also be desirable to have a thicker section with additional reinforcing fibers in certain areas of pultruded structural beams such as box beams or I-beams for added strength.

While demonstrations of profiles having these non-uniform cross sections has been done as part of research and development efforts using a traditional single die, use of a single die can be problematic for consistent high volume production. Further, prior art non-uniform cross sections manufactured using a typical single pultrusion die have proven problematic for multiple reasons.

First, polymerization of the resin matrix is accomplished by heating the resin as the fibers and resin pass through the pultrusion die. A thick cross section requires more heat and dwell time to initiate polymerization and achieve an acceptable level of cure. Consequently, the thick section, such as the leading edge slug, dictates the productive line speed. With a single pultrusion die, the productive line speed is limited by the curing of the thickest cross section. Thus, the thin section of the remaining profile body sees more heat and dwell time than necessary when pultruded at the same time.

Second, the length of the die, the resin, the catalyst, and/or the hardener choices, along with die heat profile, may be different for the portion of a profile with a thick cross section, such as the leading edge slug for an airfoil. In addition, more internal lubricants may be desirable for the portion of a profile with a thin cross section, and no, or less, lubricants or mold releases may be used for the portion of a profile with a thick cross section. Therefore, pultruding a profile with both thin and thick portions requires compromising on these choices. Thus, fewer options are available to optimize the pultrusion of the thick and thin sections of the airfoil or other profiles when it is done in the same die.

Third, the de-bulking action of pulling the large mass of leading edge slug fibers into the typical single die tends to displace the die mandrels towards the trailing edge of the outer mold line portion of the die, thus increasing pull loads, binding the profile, and potentially creating a non-straight airfoil.

Fourth, when thick and thin cross sections are pultruded at the same time there is greater drag or pull force for the thick section, which can result in a curved finished profile.

Thus, using a single die for manufacturing pultruded parts of this type is slow and is prone to downtime and the need for corrective action, which leads to inconsistent product and yield.

This present invention provides a solution for pultruding hollow and solid profiles having non-uniform cross sections that overcomes these problems.

### BRIEF SUMMARY OF THE INVENTION

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

The present invention provides a pultrusion process and method using one die for pultruding a thick cross section portion of a hollow or solid profile that is placed upstream from the primary pultrusion die, which is used for pultruding a thinner or hollow cross section portion of the profile. More specifically, a method and process for pultrusion of composite hollow and solid profiles, such as airfoil profiles, having non-uniform cross sections where the pultrusion of the heavy cross section is performed in-line and upstream from the remainder of the pultruded profile in order to optimize the processing conditions, productivity and consistency of product produced, is disclosed.

According to the present invention, portions of the pultrusion process for the thick cross section portion and for the thin cross section portion of the profile operate concurrently in the production line. However, by sequencing the pultrusion of the thicker cross section before integrating it into the thinner cross section portion of the profile, the process eliminates the problems found in prior art approaches and allows each step of the process to be optimized for greater productivity and consistency.

In an example embodiment, this invention provides a pultrusion process and method using a separate die for pultruding the thicker cross section leading edge slug upstream from the primary pultrusion die for the profile body, which is a thinner or hollow section. By sequencing the pultrusion of the thicker cross section of the leading edge slug before integrating it into the profile body, airfoil body or other shape made by the primary die, the process eliminates problems found in prior art approaches and allows the two steps of the process to be optimized for greater productivity and consistency.

This embodiment is particularly suited for a composite profile or airfoil where the leading edge has a thick cross section because the leading edge slug entering the primary pultrusion die is fully formed and complete, or net-to-size. Therefore, the portion of the profile with the thick cross section does not push the mandrels shaping the airfoil or other composite profile towards the trailing edge of the outer mold line portion of the primary die. This prevents binding the mandrels, which can result in a curved or crooked shape of the airfoil or other composite profile.

In contrast, if only one die is used, the portion of the profile with the thick cross section is not net-to-size and thus pushes the mandrels towards the trailing edge, which increases pull loads and can lead to a crooked or curved airfoil or other profile. This is because when only one die is used, the large mass of un-de-bulked fibers and wet resin in the portion of the profile with the thick section enter the single die and displace the mandrels. The present invention avoids this problem because the leading edge slug is net-to-size as it enters the primary pultrusion die with the rest of the profile materials.

The complexity and congestion of the infeed section for the materials for the airfoil or other profile is also reduced when the thick section leading edge slug or other thick cross section portion of a profile is sequenced upstream from the materials infeed and wet out stations of the profile body. Thus, the process is less congested, which contributes to productivity improvement and less down-time for corrective action.

Accordingly, one or more embodiments of the present invention overcomes one or more of the shortcomings of the known prior art.

For example, in one embodiment, a method for pultrusion of a composite profile having a non-uniform cross section comprises providing a leading edge slug die for pultruding a leading edge slug of the composite profile; providing a primary pultrusion die downstream from the leading edge slug die for pultruding a profile body of the composite profile; threading a first set of fibers into the leading edge slug die; threading a second set of fibers into the primary pultrusion die; heating the leading edge slug die; heating the primary pultrusion die; adding a first resin to a leading edge slug wet out bath; pulling the first set of fibers and the first resin through the leading edge slug die to form the leading edge slug; adding a second resin to a main wet out bath; integrating the leading edge slug with the profile body to form the composite profile by pulling the leading edge slug through the primary pultrusion die while pulling the second set of fibers and the second resin through the primary pultrusion die to form the profile body.

In this embodiment, the method can further comprise pulling the first set of fibers and the first resin through the leading edge slug die to form the leading edge slug further comprises inserting a wire rope for forming a leading edge weight insert; partially curing the leading edge slug with the leading edge slug die; or completing curing of the leading edge slug with the primary pultrusion die.

In another example embodiment, a composite profile having a non-uniform cross section is manufactured by a process comprising the steps of providing a leading edge slug die for pultruding a leading edge slug of the composite profile; providing a primary pultrusion die downstream from the leading edge slug die for pultruding a profile body of the composite profile; threading a first set of fibers into the leading edge slug die; threading a second set of fibers into the primary pultrusion die; heating the leading edge slug die; heating the primary pultrusion die; adding a first resin to a leading edge slug wet out bath; pulling the first set of fibers and the first resin through the leading edge slug die to form the leading edge slug; adding a second resin to a main wet out bath; integrating the leading edge slug with the profile body to form the composite profile by pulling the leading edge slug through the primary pultrusion die while pulling the second set of fibers and the second resin through the primary pultrusion die to form the profile body.

In this embodiment, the composite profile having a non-uniform cross section manufactured by the disclosed process can further comprise wherein the first resin comprises a vinyl ester resin and the second resin comprises an epoxy resin; wherein the first set of fibers comprises carbon fibers and the second set of fibers comprises glass fibers; further comprising feeding wire rope into the leading edge slug for forming a leading edge weight insert; further comprising partially curing the leading edge slug with the leading edge slug die; or completing curing of the leading edge slug with the primary pultrusion die.

In another example embodiment, a pultrusion tooling system for pultruding a composite profile having a non-uniform cross section comprises a leading edge slug die for pultruding a first portion of the composite profile having a first cross section thickness; a primary pultrusion die for pultruding a second portion of the composite profile having a second cross section thickness, wherein the second cross section thickness is less than the first cross section thickness; a leading edge wet out bath for adding a first resin to the first portion of the composite profile; a mandrel for shaping the second portion of the composite profile; an overwrap infeed tool for wrapping fibers around the mandrels; and a main wet out bath for adding a second resin to the second portion of the composite profile.

In this embodiment, the pultrusion tooling system can further comprise a wire rope spool for feeding wire rope into a first portion of the composite profile; or wherein the leading edge slug die has a length greater than a length of the primary pultrusion die

The present invention is also suitable for any pultruded profile having non-uniform mass through its cross section. Without limitation, examples of other possible products and applications include structural box beams having heavy upper and lower spar caps, monolithic I-Beams that are not hollow but, for example, have a heavier cap than web, or any other pultruded composite structural shape having non-uniform cross sections.

### BRIEF DESCRIPTION OF THE DRAWINGS

FIG. 1 illustrates a cross-sectional view of an example composite profile having a leading edge slug and a profile body made by the pultrusion process and method of the present invention.

FIG. 2 illustrates a top view of a pultrusion tooling and set-up for pultrusion of a composite profile wherein a separate leading edge slug die for pultruding the leading edge slug is upstream from the primary pultrusion die for pultruding the profile body.

FIG. 3 illustrates an example flow diagram for the pultrusion process of the present invention.

FIG. 4 illustrates a cross-sectional view of an example I-beam having a thick cap section and a thin web section made by the pultrusion process and method of the present invention.

FIG. 5 illustrates a cross-sectional view of an example box-beam having a thick cap section and a thin web section made by the pultrusion process and method of the present invention.

### DETAILED DESCRIPTION OF THE INVENTION

The following is a detailed description of embodiments to illustrate the principles of the invention. The embodiments are provided to illustrate aspects of the invention, but the invention is not limited to any embodiment. The scope of the invention encompasses numerous alternatives, modifications, and equivalents. The scope of the invention is limited only by the claims.

While numerous specific details are set forth in the following description to provide a thorough understanding of the invention, the invention may be practiced according to the claims without some or all of these specific details.

Various embodiments will be described in detail with reference to the accompanying drawings. Wherever possible, the same reference numbers are used throughout the drawings to refer to the same or like parts. References made to particular examples and implementations are for illustrative purposes and are not intended to limit the scope of the claims.

Composite Profiles 100

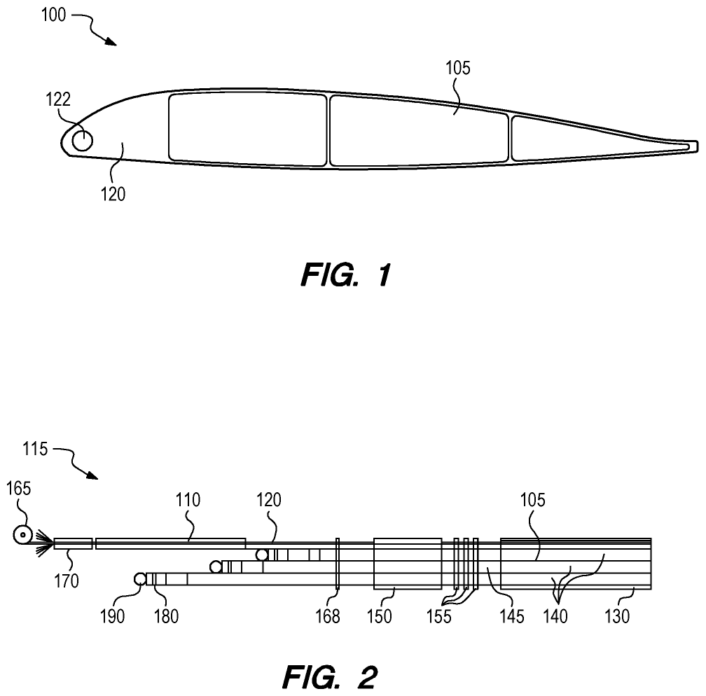

FIG. 1 illustrates an embodiment of a composite profile 100 comprising a leading edge slug 120 with a leading edge weight insert 122, and a profile body 105, made by the pultrusion process and method of the present invention. The leading edge slug 120 is made using a pultruded mix of fibers and resin. The profile body 105 is made using a pultruded mix of fibers and resin, and shaped by mandrels 140 as shown in FIG. 2.

Pultrusion Tooling 115

FIG. 2 illustrates the pultrusion tooling 115 and set-up for pultrusion of a composite profile, and in particular for pultrusion of airfoil profiles, such as composite profile 100, having non-uniform cross sections. As shown in FIG. 2, a separate leading edge slug die 110 for pultruding the leading edge slug 120 is used upstream of a primary pultrusion die 130 for pultruding the profile body 105 using the pultrusion tooling 115.

Pultrusion machines suitable for use in conjunction with the pultrusion tooling 115 are well known in the art and therefore are not described in detail here. However, a pultrusion machine that has the pulling capacity and capability to handle the desired size for the composite profile being pultruded should be used. Examples pultrusion machines are built by Pultrex, Martin Pultrusion Group, and Strongwell. Pultrusion tooling 115 shown in FIG. 2 is positioned at the upstream end of the pultrusion machine. The pultrusion machine provides the capability of pulling the materials through the process and cutting composite profile 100 to the desired length.

Pultrusion tooling 115 for making composite profile 100 in conjunction with a pultrusion machine comprises a leading edge slug die 110, a primary pultrusion die 130, mandrels 140, a main wet out bath 150, an overwrap infeed tool 168, a wire rope spool 165, a leading edge wet out bath 170, a mandrel infeed fold tool 180, and a mandrel anchor 190.

Mandrels 140 as required to shape the profile body 105 during pultrusion are inserted into the pultrusion tooling 115 with mandrel infeed fold tool 180 and secured by mandrel anchor 190. The overwrap infeed tool 168 wraps the fibers around the mandrels 140 to be fed into the main wet out bath 150 and primary pultrusion die 130 during pultrusion.

Fiber plies come off rolls and go into overwrap infeed tool 168 that continuously wraps the fibers around the mandrels 140 without wrinkles. The wrapped fibers then travel through the main wet out bath 150 and into the primary pultrusion die 130 along with the leading edge slug 120 that is pultruded upstream from primary die 130.

The fibers are threaded through both the leading edge slug die 110 and primary pultrusion die 130 at “string-up” before beginning the pultrusion process, before resin is added, and before the leading edge slug die 110 and primary pultrusion die 130 are heated. Resin is added by the main wet out bath 150 and leading edge wet out bath 170 during the pultrusion process, and excess resin is removed with the squeeze out-plates 155.

In one embodiment, wire rope is fed into the pultrusion tooling 115 via the wire rope spool 165 for forming the leading edge weight insert 122 of the leading edge slug 120. In this embodiment, the wire rope increases the weight of the leading edge slug 120, but use of wire rope is not required.

The leading edge slug die 110 is heated to partially cure the fibers and resin from the leading edge wet out bath 170 into the pultruded leading edge slug 120. The leading edge slug 120 exits the leading edge slug die 110 and is inserted into and becomes a part of the profile body 105 during pultrusion to form the composite profile 100. During pultrusion, the profile body 105 passes through the main wet out bath 150, the squeeze-out plates 155, and the primary pultrusion die 130.

The primary pultrusion die 130 is heated to cure the fibers and resin into the profile body 105, and to complete the cure of the leading edge slug 120 if it is not completely cured by the leading edge slug die 110.

Gripper pullers, which are not shown but are well known in the art, pull fibers and resin through both the leading edge slug die 110 and the primary pultrusion die 130 at the same time once pultrusion start-up is completed and the pultrusion process is running in steady-state production. However, pultrusion of the leading edge 120 must be started first.

As the pultruded leading edge slug 120 exits the leading edge slug die 110 and is being pulled along it enters the primary pultrusion die 130. The two pultrusion operations are then ongoing concurrently with the leading edge slug 120 exiting the upstream leading edge slug die 110 and passing into the profile body 105 as both are then pultruded by the primary pultrusion die 130 to ultimately become the composite profile 100.

In one embodiment, fibers for the leading edge slug 120 and profile body 105 can comprise a higher modulus carbon fiber to increase longitudinal stiffness of the airfoil blade, which may be particularly desirable for the leading edge slug 120. In an alternative embodiment, fibers can also comprise glass fibers. Alternatively, pre-preg materials or partially cured materials can be used as materials for the leading edge slug 120 before it is integrated with the profile body 105 to form a composite profile, such as composite profile 100.

In another embodiment, different fibers may be used for the leading edge slug 120 than for the profile body 105. For example, carbon fibers may be used for the leading edge slug 120 and glass fibers may be used for the profile body 105 to reduce cost of the composite profile 100 yet still meet strength requirements. Additionally, the coefficient of thermal expansion of the different fibers can be better managed when the leading edge slug 120 is fully cured and enters the primary pultrusion die 130 with the fibers including carbon fibers.

In one embodiment, resins for the leading edge slug 120 and profile body 105 can comprise polyester or vinyl ester resins typically used in commercial pultruded products. However, these resins are very reactive, and thus when heated by the leading edge slug die 110 and primary pultrusion die 130 they can cure completely. In another embodiment, resins can comprise epoxies typically used for aerospace applications. Epoxy is slower to cure than the resins typically used in commercial pultruded products. However, for epoxies, there are hardener systems known in the art that can be used that have faster polymerization or cure time.

In one embodiment, when the leading edge slug 120 exits the leading edge slug die 110, the leading edge slug 120 is solid or hard to the touch but is not completely cured. If the leading edge slug 120 is not fully cured, but still semi-hard to the touch, then the resins for the profile body 105 bind well to the leading edge slug 120 as both pass through the primary pultrusion die 130. Therefore, the cure characteristics of the resins can be used to enhance the adhesion of the leading edge slug 120 to the profile body 105 as the profile body 105 passes through the primary pultrusion die.

Additionally, the resins in the main wet out bath 150 and leading edge wet out bath 170 for the heavy cross section of the leading edge slug 120 can be tailored to optimize overall production. In one embodiment, the formulation of the resins and the catalyst used can be tailored to speed up cure time, and for epoxies there are hardener systems known in the art that have faster polymerization or cure time that can be used.

In another embodiment, the ability to separately tailor the processes for the leading edge slug 120 and the profile body 105 can be taken to the point where a different resin mix is used for the leading edge slug 120 from that used for the profile body 105. For example, a vinyl ester resin may be suitable for the leading edge slug 120, while an epoxy resin may be more suitable for the profile body 105 depending on application requirements.

Pultrusion Process 300

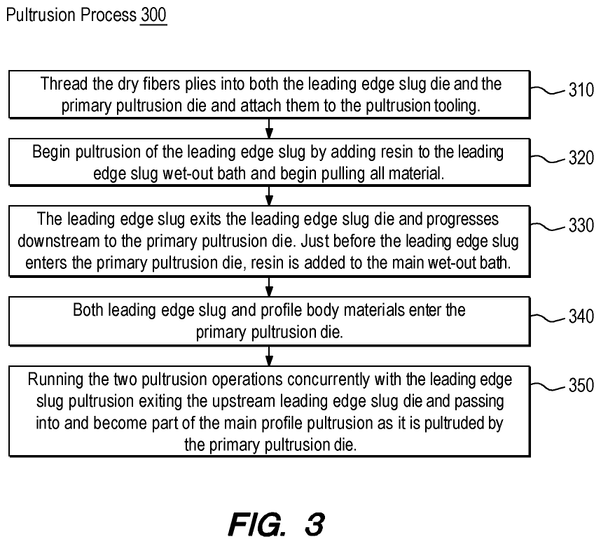

Turning to FIG. 3, the pultrusion process 300 utilizing the pultrusion tooling 115 on an industry available pultrusion machine that has the pulling capacity and capability to handle the desired size of the composite profile 100 is shown. Pultruding the leading edge slug 120 and profile body 105 using separate dies using the pultrusion process 300 eliminates the process problems of prior art methods and allows these two segments of the pultrusion process to be optimized for greater productivity and consistency.

First, at step 310, the dry (no resin) fibers are threaded into both the leading edge slug die 110 and the primary pultrusion die 130 and attached to the pultrusion tooling 115. The dry fibers are also attached to the pultrusion machine start-up winch (not shown) just downstream of the gripper pullers and of the primary pultrusion die 130.

Next, at step 320, pultrusion of the larger cross section of the leading edge slug 120 begins by adding resin to the leading edge slug wet out bath 170 and pulling all material. When resin is applied to the process, the start-up winch pulls the composite profile 100 downstream until the gripper pullers can be closed onto the composite profile 100. At this point, the start-up winch is disengaged, and the gripper pullers perform the task of continuously pulling materials.

At step 330, the leading edge slug 120 exits the leading edge slug die 110, and just before the leading edge slug 120 enters the primary pultrusion die 130, resin is added to the main wet out bath 150. The fibers are also re-clamped to the start-up winch at this point to reduce the amount of dry (no resin) fiber materials pulled. Then, at step 340, the leading edge slug 120 enters the primary pultrusion die 130.

At step 350, the two pultrusion operations are then ongoing concurrently with the leading edge slug 120 exiting the upstream leading edge slug die 110 and passing into and becoming part of the profile body 105 as it is pultruded by the primary pultrusion die 130. And, after the complete composite profile 100 comprised of both leading edge slug 120 and profile body 105 exits the primary pultrusion die 130 in a fully cured state and progresses downstream far enough to engage the gripper pullers of the pultrusion machine, the transfer from start-up winch to the pultrusion machine's gripper pullers is completed.

In this the pultrusion process 300, in one embodiment, the upstream leading edge slug 120 is solid but not yet completely cured exiting the leading edge slug die 110 at step 330. Its cure is completed at step 340 as it is co-cured with the profile body 105 as both are pulled through the primary pultrusion die 130. This is because the leading edge slug 120 is encapsulated by the fiber plies of the profile body 105 upstream of the primary pultrusion die 130 such that it is co-cured with the profile body 105 to become the composite profile 100. While fully encapsulated in the profile body 105, the cure of the leading edge slug 120 can also be optimized to be at lower percent of cure completion when it exits the upstream leading edge slug die 110 to enhance adhesion to the profile body 105.

Furthermore, during start-up, the main wet out bath 150 does not yet contain resin, and the fibers of the profile body 105 are dry. However, the primary pultrusion die 130 is hot. Therefore, just before the leading edge slug 120 begins to enter the primary pultrusion die 130 at step 330, resin is then added to the main wet out bath 150. The fibers of the profile body 105 are then “wet out” with resin as the leading edge slug 120 and fibers and resin of the profile body 105 enter the primary pultrusion die 130 at step 340. As a result, the profile body 105 is co-cured with the leading edge slug 120, and the composite profile 100 is subsequently pultruded in a continuous manner by the pultrusion tooling 115 as the two pultrusion operations run concurrently at step 350.

In one embodiment, the pull speed for the leading edge slug 120 and profile body 105 remains the same for both the leading edge slug die 110 and primary pultrusion die 130 at step 350, but the processing conditions can be optimized for each. In one embodiment, the time for pultrusion of the leading edge slug die 110 can be longer than the time for the primary pultrusion die 130 to provide more cure dwell time for the leading edge slug 120 at a given pull speed, different heat profiles, and to optimize the overall process for the larger mass and cross section of the leading edge slug 120 independent of the primary pultrusion die 130.

As another embodiment, pultrusion start-up of a complex composite profile 100 is made easier by first starting the pultrusion of the leading edge slug 120 and stabilizing this part of the pultrusion process before starting the pultrusion process for the profile body 105 at step 330. A stabilized pultrusion process is one wherein the fibers and resin enter the die in a controlled manner without bunching up and are adequately cured and dimensionally correct. For example, if the die temperature is too low at start-up, the material exiting the die might not be cured. In this case, the process is not working and is not yet stabilized.

Alternative Composite Profiles 400 and 500

The composite profile 100 made by the pultrusion process and method disclosed herein is particularly suited for a rotor blade airfoil where the leading edge slug 120 has a thick cross section because the leading edge slug 120 entering the primary pultrusion die 130 is net-to-size and therefore does not push the mandrels 140 sideways towards the trailing edge of the outer mold line portion of the primary pultrusion die 130. This prevents binding the mandrels 140 which increases pull loads and leads to a crooked or curved airfoil or other composite profile. However, this invention is also suitable for any hollow or solid pultruded profile having non-uniform thickness through its cross section.

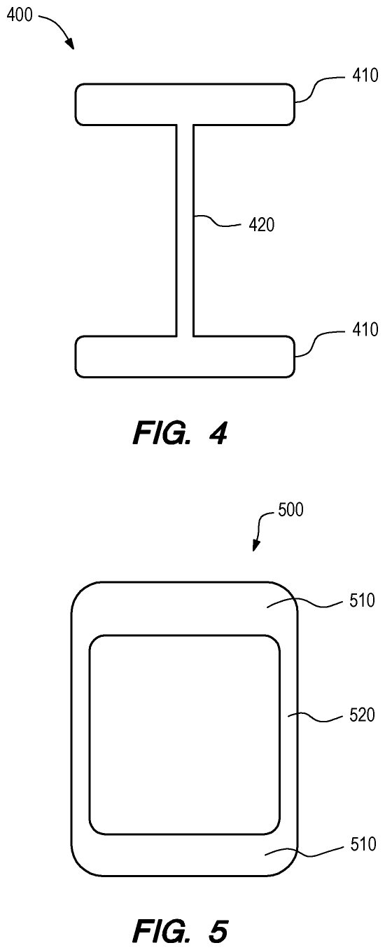

For example, as shown in FIG. 4, in one alternative embodiment made by the pultrusion process and method of the present invention, composite profile 400 comprises an I-beam. Composite profile 400 has a thick cap section 410 and a thin web section 420. The thick cap section 410 is pultruded in the leading edge slug die 110, and then integrated with the thin web section 420 to go through the primary pultrusion die 130 to form composite profile 400.

As another example, as shown in FIG. 5, in another alternative embodiment made by the pultrusion process and method of the present invention, composite profile 500 comprises a box-beam. Composite profile 500 has a thick cap section 510 and a thin web section 520. Again, the thick cap section 510 is pultruded in the leading edge slug die 110, and then integrated with the thin web section 520 to go through the primary pultrusion die 130 to form composite profile 500.

While the invention has been specifically described in connection with certain specific embodiments thereof, it is to be understood that this is by way of illustration and not of limitation. Reasonable variation and modification are possible within the scope of the foregoing disclosure and drawings without departing from the spirit of the invention.

I claim:

1. A method for pultrusion of a composite profile having a non-uniform cross section comprising:
providing a leading edge slug die for pultruding a leading edge slug of the composite profile;
providing a primary pultrusion die downstream from the leading edge slug die for pultruding a profile body of the composite profile;
threading a first set of fibers into the leading edge slug die;
threading a second set of fibers into the primary pultrusion die;
heating the leading edge slug die;
heating the primary pultrusion die;
adding a first resin to a leading edge slug wet out bath;
pulling the first set of fibers and the first resin through the leading edge slug die to form the leading edge slug;
adding a second resin to a main wet out bath; and
integrating the leading edge slug with the profile body to form the composite profile by pulling the leading edge slug through the primary pultrusion die while pulling the second set of fibers and the second resin through the primary pultrusion die to form the profile body.

2. The method of claim 1 wherein pulling the first set of fibers and the first resin through the leading edge slug die to form the leading edge slug further comprises inserting a wire rope for forming a leading edge weight insert.

3. The method of claim 1 further comprising partially curing the leading edge slug with the leading edge slug die.

4. The method of claim 3 further comprising completing curing of the leading edge slug with the primary pultrusion die.

5. A composite profile having a non-uniform cross section manufactured by a process comprising the steps of:
providing a leading edge slug die for pultruding a leading edge slug of the composite profile;
providing a primary pultrusion die downstream from the leading edge slug die for pultruding a profile body of the composite profile;
threading a first set of fibers into the leading edge slug die;
threading a second set of fibers into the primary pultrusion die;
heating the leading edge slug die;
heating the primary pultrusion die;
adding a first resin to a leading edge slug wet out bath;
pulling the first set of fibers and the first resin through the leading edge slug die to form the leading edge slug;
adding a second resin to a main wet out bath; and
integrating the leading edge slug with the profile body to form the composite profile by pulling the leading edge slug through the primary pultrusion die while pulling the second set of fibers and the second resin through the primary pultrusion die to form the profile body.

6. The composite profile manufactured by the process of claim 5 wherein the first resin comprises a vinyl ester resin and the second resin comprises an epoxy resin.

7. The composite profile manufactured by the process of claim 5 wherein the first set of fibers comprises carbon fibers and the second set of fibers comprises glass fibers.

8. The composite profile manufactured by the process of claim 5 further comprising inserting a wire rope into the leading edge slug for forming a leading edge weight insert.

9. The composite profile manufactured by the process of claim 5 further comprising partially curing the leading edge slug with the leading edge slug die.

10. The composite profile manufactured by the process of claim 9 further comprising completing curing of the leading edge slug with the primary pultrusion die.

11. A pultrusion tooling system for pultruding a composite profile having a non-uniform cross section comprising:
a leading edge slug die for pultruding a first portion of the composite profile having a first cross section thickness;
a primary pultrusion die for pultruding a second portion of the composite profile having a second cross section thickness, wherein the second cross section thickness is less than the first cross section thickness;
a leading edge wet out bath for adding a first resin to the first portion of the composite profile;
a mandrel for shaping the second portion of the composite profile;
an overwrap infeed tool for wrapping fibers around the mandrel; and
a main wet out bath for adding a second resin to the second portion of the composite profile.

12. The pultrusion tooling system of claim 11 further comprising a wire rope spool for inserting a wire rope into the first portion of the composite profile.

13. The pultrusion tooling system of claim 11 wherein a length of the leading edge slug die is greater than a length of the primary pultrusion die.
